(19) United States
(12) Patent Application Publication
(10) Pub. No.: US 2005/0141684 A1
(43) Pub. Date: Jun. 30, 2005

(54) System and method for purchasing retail goods using a telephone

(76) Inventor: Alfred Atome Ogbumor, Ottawa (CA)

Correspondence Address: ALFRED OGBUMOR, 2046 SCULLY WAY, OTTAWA, ON, K4A 4L8, CA

(21) Appl. No.: 10/823,606

(22) Filed: Apr. 14, 2004

(30) Foreign Application Priority Data
Dec. 30, 2003 (CA) 2,452,423

(51) Int. Cl. H04M 11/00; G06F 12/00

(52) U.S. Cl. 379/93.12

(57) ABSTRACT

A system and method for purchasing retail goods using a telephone having a video display is described. A user contacts a store server and receives video and audio data relating to store items. The user selects a set of store items and a delivery method and then authorizes the purchase. Optionally, the user first contacts a server directory that directs the user to an appropriate store server.

### FIELD OF THE INVENTION

The invention relates to the purchase of goods involving ordering goods by telephone. More specifically, the invention relates to a system and method for ordering various goods over by telephone incorporating a video display.

### BACKGROUND

The use of the Internet to bring consumers and retailers together has increased dramatically in recent years. However, many consumers do not understand how to use the Internet and reluctant to do so. Additionally, many consumers are reluctant to provide credit card numbers to their computer.

In contrast, some television stations provide infomercials in which items are advertised for sale. The business has a series of people who receive telephone calls from interested consumers. Although this method has proven effective in selling some items it does not allow the consumer to choose what items are provided. In comparison with Internet shopping, this method is costly due to the need for reserving television broadcasting time and employing people to receive phone calls.

It would be beneficial to provide a service that allows consumers to shop from their homes without the need for a computer and the knowledge of how to use it, while providing a wide variety of different products.

### SUMMARY OF THE INVENTION

The invention teaches a method of ordering retail goods comprising: providing a telephone having a video display; providing a retail store server, the retail store server for storing item data relating to items available for purchase; establishing a point to point communication link between the telephone and the retail store server, the point to point communication link; providing a user video data corresponding to item data; and, providing user input data in response to the video data, the input data indicative of an intent to purchase at least an item of the items available for purchase.

### BRIEF DESCRIPTION OF THE DRAWINGS

The invention is now described with reference to the figures in which:

FIG. 1 is a schematic diagram of a data network for use in providing consumer data to a user with a telephone according to the invention;

FIG. 2 is a sample menu for a grocery purchasing system according to the invention;

FIG. 3 is a sample menu indicating a list of items to be purchase for a system according to the invention; and,

FIG. 4 is a sample menu providing payment and delivery options for a system according to the invention.

### DETAILED DESCRIPTION OF THE INVENTION

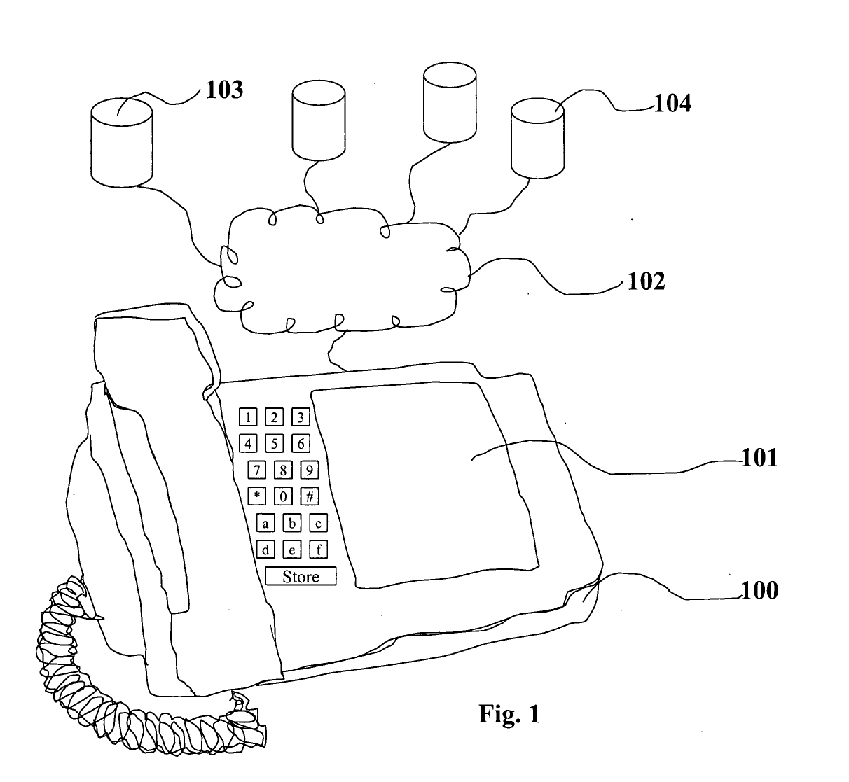

Referring to FIG. 1, a network of device for use with a first embodiment of the invention is illustrated. FIG. 1 includes a telephone 100 with an integrated video display 101, a telephone communications point to point network 102, a directory server 103 and a store server 104. The telephone supports standard telephone operations known to a person of skill in the art as plain old telephone service (POTS). The services supported by POTS comprise: bi-directional, or duplex, speech path, dial tone and ringing signals, subscriber dialing and, operator services, such as directory assistance and long distance and conference calling assistance. In use, a user dials a telephone number corresponding to the directory server 103 and thereby establishes a communications link with the directory server 103 via the point to point network 102. The directory server 103 provides a list of store categories. The user selects a category and the directory server 103 provides a list of stores of the chosen category. Optionally, the directory server 103 provides a list of locations, the list of locations comprising the names of the various regions supported by the directory server 103. Further optionally, the directory server 103 provides map data indicative of local regions having supported stores. The map data is provided to the user via the video display 101. When a region is selected a list of supported stores within the region is provided. The user then selects a store from the list of stores.

In a case where the telephone 100 comprises a memory for retaining telephone numbers the telephone numbers of the directory server 103 and any selected store servers are stored for future use. Thus, once a store server 104 is selected the telephone 100 records the store sever telephone number 104 thereby allowing the user access the same store server without contacting the directory server 103 again. This quickens the operation of the system according to the first embodiment of the invention since the user is then able to access servers by simply pressing a button.

Having selected a store, a data communications link is established between the telephone 100 and the store server 104. This is optionally achieved in any of a variety of ways. In a first case, the directory server 103 optionally provides data corresponding to the selected store is provided to the telephone and stored. The communications link between the telephone 100 and the directory server 103 is then terminated. The telephone 100 establishes a communications link with the store server 104 corresponding to the data provided directory server 103. In a second case, the directory server 103 initiates a data communications link between the telephone 100 and the store server 104. Once the telephone 100 is in data communications with the store server 104 there is no need for a data communications link between the telephone 100 and the directory server 103 and therefore it is suggested that the data communications link to the directory server 103 be terminated. The store server 104 provides data to the telephone 100 indicative of products and pricing. The user then selects products, quantities of those products, a delivery option and a method of payment.

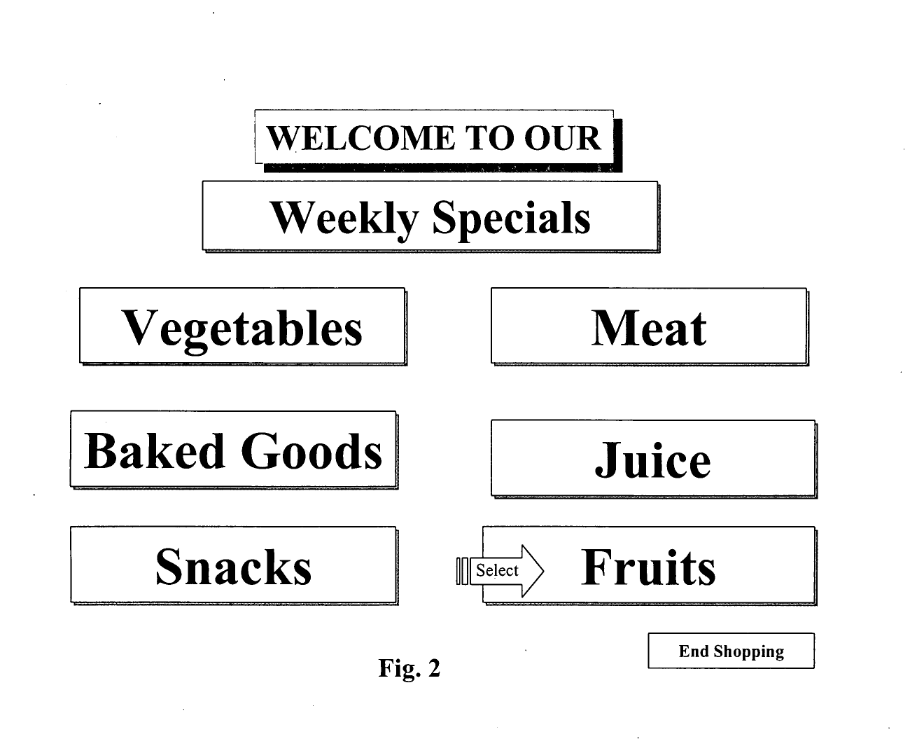

Referring to FIG. 2, an image consistent with data provided by a store server 104 for the video display 101 is shown. The video display 101 provides a simple directory that directs a user to specific items that they wish to purchase. For the purposes of this example the user wishes to purchase groceries and has selected a grocery store server. The grocery store server provides data associated with grocery store items. In the menu shown in FIG. 2, the grocery store items are classified as one of: vegetables, meat, baked goods, juice, snacks, and fruits. Additionally, a weekly specials category is provided. Further, an option to end shopping is provided. Each of the classifications is broken down into sub-classifications until specific products are determined. Specific products are shown with a price. The user selects one of these categories in any of a variety of ways. For example, in one case, the user presses a button on the telephone 100 corresponding to the selection. In a second case, the store server 104 incorporates voice recognition software and the user chooses a menu verbally. In a third case, the video display 101 comprises a tactile contact sensor and the user indicates their selection by pressing a location on the video display 101. Clearly, these cases are not mutually exclusive and, thus, in a fourth case the user indicates their selection using any one of a verbal command, the pressing of a button, and the pressing of a portion of the video display 101. The user selects a desired quantity of the item and the system reverts to the previous menu. Once the user has provided their list of groceries an “end shopping” option is selected.

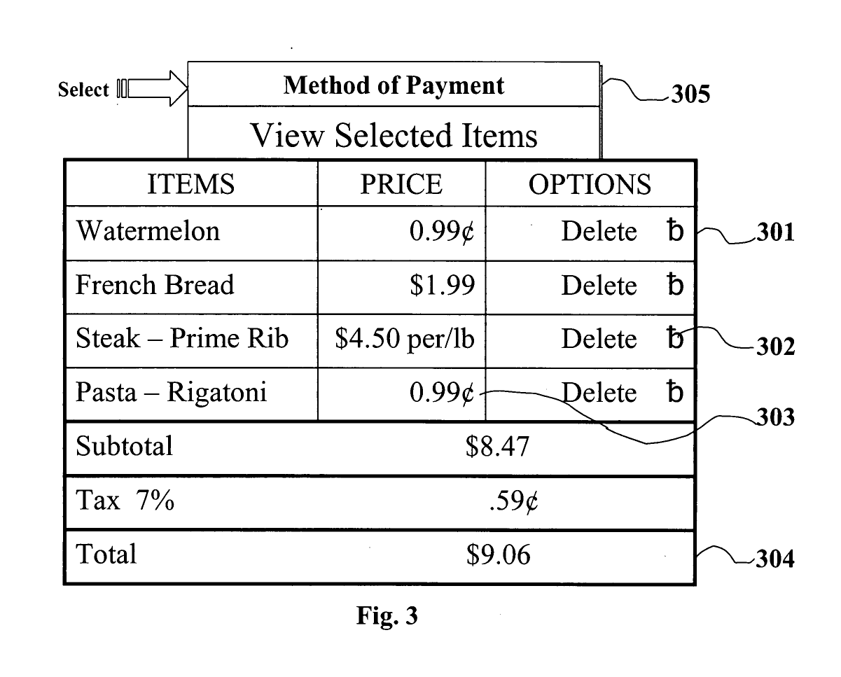

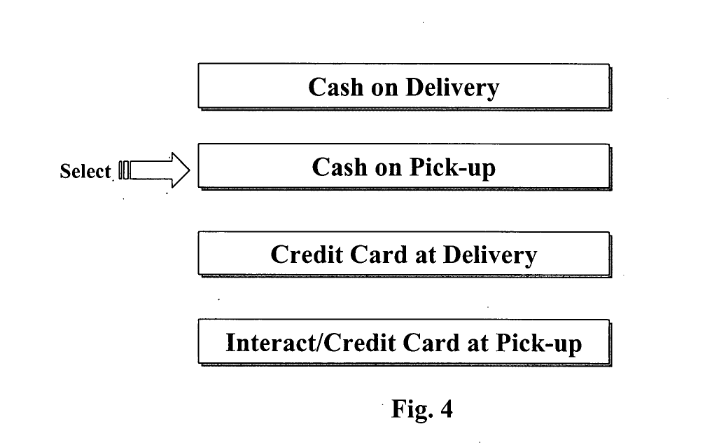

In the system according to the first embodiment of the invention, once the user has provided their data a list of the selected items is provided. Referring to FIG. 3, an image consistent with a representative purchase list is shown for a case in which the system according to the first embodiment of the invention is applied to grocery purchasing. The video display 101 displays the purchase list menu that comprises: a list of all items selected 301, a selection box 302 to allow individual items to be deleted from the selection, a price information box 303 for each selected item, a total cost box 304, a method of payment box 305 and a continue box 306. The user is given the opportunity to review their list of groceries and optionally deleted entries using the selection box 302. The user optionally provides data indicative of a method of payment by activating the method of payment box 305 to bring up a method of payment screen. When the user is satisfied with their choices a button corresponding to the continue box 306 is activated. Referring to FIG. 4 an exemplary delivery and payment menu is shown. This menu allows the user to choose how the grocery purchase is to be supplied and paid for. Clearly, some delivery options may incur an additional cost, which is optionally shown adjacent the delivery option. If the user chooses to have their groceries delivered then a menu will be provided to query the user for an address, and delivery time. When ready, the user presses a button to complete the transaction. When the transaction is complete the data communications link established between the telephone 100 and the store server 104 is terminated.

User information regarding user purchase history is optionally stored in the store server. This allows the store sever to provide an old list to an existing user. This substantially speeds up the purchase process as many items are purchased on a regular basis. Thus, a user might purchase certain groceries on a regular basis. If the user purchases specific brands of food items then it is beneficial to provide a list of groceries previously purchased by the user thereby reducing the time that the user spends providing their selections.

A person of skill in the art will appreciate that a system according to the invention need not be limited to the purchase of groceries. Alternative embodiments of the invention support the purchase of other retail goods instead of groceries. The invention is of particular value for selling items or groups of items that are difficult for individuals to transport, yet that are sufficiently generic that it is not necessary to inspect the item prior to purchasing it. Thus, the system according to the first embodiment of the invention is well suited to purchasing for example, a television. Thus, a consumer might see a television at the home of a friend; the consumer would then note the model and manufacturer of the television. Additionally, the sale of a variety of other consumer electronic devices, such as radios, personal stereo systems and video cassette records is supported by a system according to the invention. In this way, the consumer does not need to go to a store to make the purchase. In this case, the retailer does not need to be local to the consumer. Alternatively, a store selling compact discs (CDs) and digital video discs (DVDs) need not operate a conventional store in order to sell their items using the system according to the invention. For example, the virtual media store has a toll free long distance number that the user dials on their phone. The user selects the CDs and DVDs that they want and authorizes payment using, for example, a credit card. The virtual store receives the order and ships the items by mail. Other variations are easily implemented. Clearly, the purchased media is optionally shipped in any of a variety of different ways. Such as system is highly advantageous because it does not require a physical store. In this way, additional costs associated with renting or purchasing retail space are avoided thereby providing a competitive advantage and permitting substantially reduced prices.

Numerous other embodiments of the invention will be apparent to one of skill in the art.

1. A method of ordering retail goods comprising:
providing a telephone supporting plain old telephone service having a video display;
providing a retail store server, the retail store server for storing item data relating to items available for purchase;
establishing a point to point communication link between the telephone and the retail store server;
providing video data to the video display, the video data corresponding to item data; and,
providing user input data in response to the video data, the input data indicative of an intent to purchase at least an item corresponding to the item data.

2. A method of ordering retail goods according to claim 1 wherein the video data comprises price data and image data.

3. A method of ordering retail goods according to claim 2, wherein the telephone has input keys and the user input data is provided by pressing the keys.

4. A method of ordering retail goods according to claim 2, wherein the video display is responsive to tactile contact and providing user input data comprises touching the video display.

5. A method of ordering retail goods according to claim 2 wherein the retail store server comprises a speech recognition system and the user input data is provided by a user providing audio data to the telephone while the telephone is in data communication with the grocery store server.

6. A method of ordering retail goods according to claim 2 wherein the retail goods are groceries.

7. A method of ordering retail goods according to claim 2 wherein in the retail goods are pre-recorded media.

8. A method of ordering retail goods according to claim 2 wherein in the retail goods are consumer electronic devices.
